(19) United States
(12) Patent Application Publication
(10) Pub. No.: US 2026/0257347 A1
(43) Pub. Date: Sep. 3, 2026

(54) ROBOT PROGRAMMING DEVICE AND ROBOT PROGRAMMING SYSTEM

(71) Applicant: FANUC CORPORATION, Yamanashi (JP)

(72) Inventor: Hiroyuki YONEYAMA, Yamanashi (JP)

(21) Appl. No.: 18/864,546

(22) PCT Filed: Jun. 15, 2022
(86) PCT No.: PCT/JP2022/023975

§ 371 Date: Nov. 11, 2024

(51) Int. Cl. B25J 9/16; G06K 7/14

(52) U.S. Cl. CPC B25J 9/163; G06K 7/1417

(57) ABSTRACT

A robot programming device comprises: a robot program teaching unit for executing robot program teaching; and a code converting unit for converting, to code, information for specifying the robot program which was taught.

### FIELD

The present invention relates to a robot programming device and a robot programming system.

### BACKGROUND

As techniques for creating a robot program for operating a robot, a technique of teaching an operation to an actual robot by operating a teach pendant and a technique of performing teaching of a robot program by arranging a three-dimensional model of a robot system in a virtual space of a programming device are known.

In relation to the above, PTL 1 describes as follows: “In a robot system according to a modified example 1 of the present embodiment, an operation controller 100 includes: a system control unit 101; a barcode reader 104; a work program storage unit 106; and a robot control unit 107. A plurality of barcode tags in which a plurality of types of work program ID codes are respectively stored are respectively arranged at a plurality of installation positions. A work program unique to each installation position is predetermined. A barcode tag in which a work program ID unique to each work program is recorded is arranged at an installation position corresponding to each work program.” (paragraph 0050).

PTL 2 describes as follows: “A robot teaching method is a method for teaching robot 1 an operation related to work performed on a workpiece 10 and includes: an image capture step (step S2) of capturing, by a camera 6 mounted on the robot 1, an image of the workpiece 10 including a marker 15; a detection step (step S3) of detecting the marker 15 from the captured image; an analysis step (steps S4 and S5) of acquiring teaching information for operation of the robot 1 by analyzing the marker 15; and a storage step (step S6) of storing the teaching information.” (ABSTRACT).

PTL 3 relates to a configuration of a robot simulation image display system and describes as follows: “Model number information T of a robot and a demonstration program SP for operating a three-dimensional image model M are recorded in a QR code (registered trademark) 4; and a personal computer 2 acquires posture information, i.e., a rotation matrix Mr in a three-dimensional space of the QR code (registered trademark) 4 from four points P1 to P4 on a screen corresponding to four points Q1 to Q4 in image data of the QR code (registered trademark) 4 captured by a camera 1, wherein a reference point CO is the origin of the three-dimensional coordinates, directions extending from the origin to Q1 and Q2 are an X-axis and a Y-axis, respectively, and a normal line standing on the origin on the X-Y plane is a Z-axis, multiplies three-dimensional image data R by the rotation matrix Mr, and displays the three-dimensional image model M on a display 5. In accordance with change of the position and the posture of the QR code (registered trademark) 4 in an image captured by the camera 1, the position and the posture of the three-dimensional image model M is also changed, and the three-dimensional image model M is operated in three-dimensional space display in accordance with the demonstration program SP.” (ABSTRACT).

### CITATION LIST

### Patent Literature

[PTL 1] Japanese Unexamined Patent Publication (Kokai) No. 2016-215318 A

[PTL 2] Japanese Unexamined Patent Publication (Kokai) No. 2012-228757 A

[PTL 3] Japanese Unexamined Patent Publication (Kokai) No. 2010-179403 A

### SUMMARY

### Technical Problem

When applying a robot program created by the teaching to an actual robot system, for example, the robot program is registered in a robot controller via a storage medium such as a USB memory. A scenario in which an operator causes a desired program out of a plurality of robot programs registered in the robot controller to be executed is considered. In an actual robot system, the production situation of the robot system may change variously, for example, when the robot system handles many types of workpieces or when the work contents are changed. In order to cope with such changes, it may be necessary to temporarily stop the robot system and perform an operation for re-selecting a suitable robot program, or a program for calling up a suitable robot program may be newly created on the user side. However, considerable man-hours are required for these measures. A robot programming device and a robot programming system that can efficiently apply a robot program to a robot system even in situations in which the production situation of the robot system changes variously are desired.

### Solution to Problem

An embodiment of the present disclosure is a robot programming device including: a robot program teaching unit configured to perform teaching of a robot program; and a code conversion unit configured to convert information for identifying the taught robot program into a code.

Another embodiment of the present disclosure is a robot programming system including: a robot programming device including: a robot program teaching unit configured to perform teaching of a robot program; and a code conversion unit configured to convert information for identifying the taught robot program into a code; a visual sensor configured to capture an image of the code displayed on an information medium; and a robot controller configured to control a robot, the robot controller including: a code analysis unit configured to decode the information for identifying the robot program by analyzing the captured image of the code; a robot program determination unit configured to determine, based on the decoded information for identifying the robot program, a robot program corresponding to the information from one or more preregistered robot programs; and a robot program execution unit configured to execute the determined robot program.

### Advantageous Effects of Invention

The aforementioned configuration enables a robot controller to decode information for identifying a program by analyzing an image in which a code is captured, to select a robot program corresponding to the decoded information out of a plurality of preregistered robot programs, and to execute the program. Consequently, a robot program can be efficiently applied to a robot system even in situations in which the production situation of the robot system changes variously.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating an apparatus configuration of a robot programming system according to a first embodiment.

FIG. 2 is a diagram illustrating hardware configuration examples of a programming device, a robot controller, and a teach pendant.

FIG. 3 is a diagram illustrating functional blocks of the programming device and the robot controller according to the first embodiment.

FIG. 4 is a flowchart illustrating a sequence of processing from creation of a robot program to readout of a code and further to execution of the robot program.

FIG. 5 is a diagram illustrating a first example of creation of a robot program in a virtual space.

FIG. 6 is a diagram illustrating the first example of creation of a robot program in a virtual space.

FIG. 7 is a diagram illustrating a second example of creation of a robot program in a virtual space.

FIG. 8 is a diagram illustrating the second example of creation of a robot program in a virtual space.

FIG. 9 is a diagram schematically illustrating a situation in which a code is created.

FIG. 10 is a diagram illustrating the operation in a stage of readout of a code by the robot system.

FIG. 11 is a diagram illustrating the operation in a stage of execution of a determined robot program by the robot system.

FIG. 12 is a diagram illustrating functional blocks of a programming device and a robot controller according to a second embodiment.

FIG. 13 is a diagram illustrating a creation example of a robot program dependent on a workpiece.

FIG. 14 is a diagram illustrating the creation example of a robot program dependent on a workpiece.

FIG. 15 is a diagram illustrating the creation example of a robot program dependent on a workpiece.

FIG. 16 is a diagram schematically illustrating a situation in which a code is created.

FIG. 17 is a diagram illustrating the operation in a stage of execution of a determined robot program by the robot system.

FIG. 18 is a diagram illustrating the operation in the stage of execution of a determined robot program by the robot system.

FIG. 19 is a diagram for illustrating a stage in which another workpiece is put into a workspace, and a code is read.

FIG. 20 is a diagram illustrating the operation in a stage of execution of a determined robot program by the robot system.

FIG. 21 is a diagram illustrating an apparatus configuration of a robot system generating a robot program by teaching the operation to an actual robot.

### DESCRIPTION OF EMBODIMENTS

Next, embodiments of the present disclosure will be described with reference to drawings. In referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

Robot programming systems according to a first embodiment to a third embodiment will be described below. The robot programming system according to each embodiment includes a robot programming device including a robot program teaching unit configured to perform teaching of a robot program and a code conversion unit configured to convert information for identifying the taught robot program into a code, a visual sensor configured to capture an image of the code displayed on an information medium, and a robot controller configured to control a robot. In this configuration, the robot controller includes a code analysis unit configured to decode the information for identifying a robot program by analyzing a captured image of the code, a robot program determination unit configured to determine, based on the decoded information for identifying the robot program, a robot program corresponding to the decoded information from preregistered robot programs, and a robot program execution unit configured to execute the determined robot program. With this configuration, the robot controller can decode information for identifying a robot program from an image captured by the visual sensor, select a robot program corresponding to the decoded information from preregistered robot programs, and execute the program.

### First Embodiment

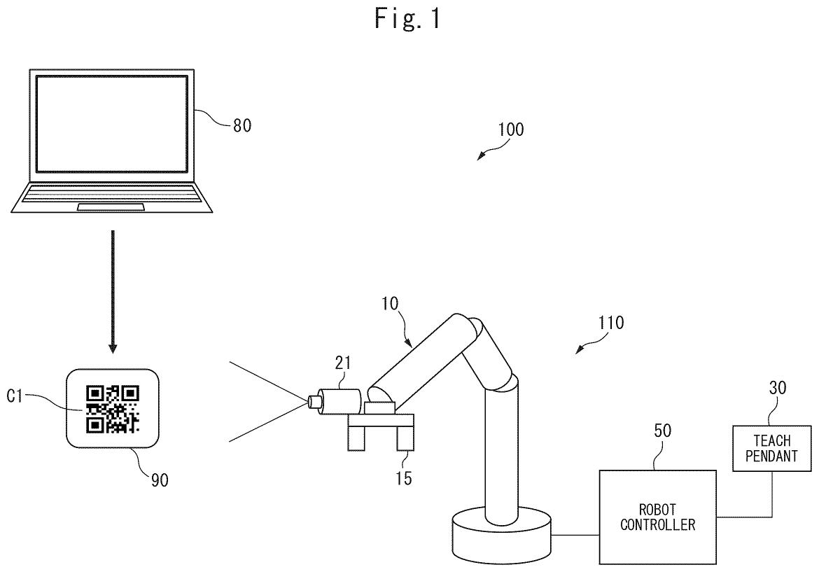

FIG. 1 is a diagram illustrating an apparatus configuration of a robot programming system 100 according to a first embodiment. As illustrated in FIG. 1, the robot programming system 100 includes a robot programming device 80 having a function of creating a robot program and converting information for identifying the robot program into a code, and a robot system 110 configured to capture an image of the code displayed on an information medium 90 with a visual sensor 21, analyze the code, and determine and execute the robot program. The information medium 90 includes any medium that can display or carry a code, such as a display screen of an information processing device or a print medium.

For example, a program name or identification information allowing unique identification of a program (hereinafter described as a program ID) may be used as information for identifying a robot program. Various codes including a one-dimensional code and a two-dimensional code may be used as a code representing such information for identifying a program. Through image analysis, the code provides information encoded therein (in a form of an encoding pattern) as decoding information. It is assumed in the present embodiment as an example that when a program name is used as the information for identifying a program, the program name is encoded by a two-dimensional code, and when a program ID is used as the information for identifying a program, the program ID is encoded by a one-dimensional code. FIG. 1 illustrates an example of a two-dimensional code C1 being displayed on the information medium 90.

The robot programming device 80 is a robot programming device that can arrange a robot system model including a robot model in a virtual space and teach the operation to the robot system model in the virtual space to create a robot program. A personal computer (PC), a tablet terminal, or another information processing device may be used as the robot programming device 80. The created robot program is registered in a robot controller 50 through, for example, an external memory (such as a USB memory).

The robot system 110 includes a robot 10, the robot controller 50 controlling the robot 10, and a teach pendant (teaching device) 30 connected to the robot controller 50. While FIG. 1 illustrates an example of the visual sensor 21 being mounted on an arm tip of the robot 10, the visual sensor 21 may be fixed in a workspace. The visual sensor 21 is connected to the robot controller 50 and operates under control of the robot controller 50.

The robot 10 can execute desired work with an end effector attached to the wrist of the arm tip. The end effector is an external device exchangeable according to the purpose and is, for example, a hand, a welding gun, or a tool. FIG. 1 illustrates an example of a hand 15 being used as an example of the end effector.

With the aforementioned configuration, the robot 10 (robot controller 50) can read, with the visual sensor 70, a code being created by the robot programming device 80 and being displayed on the information medium 90 and decode the code. Then, the robot controller 50 can determine and execute a robot program corresponding to the decoded program name or program ID out of preregistered robot programs.

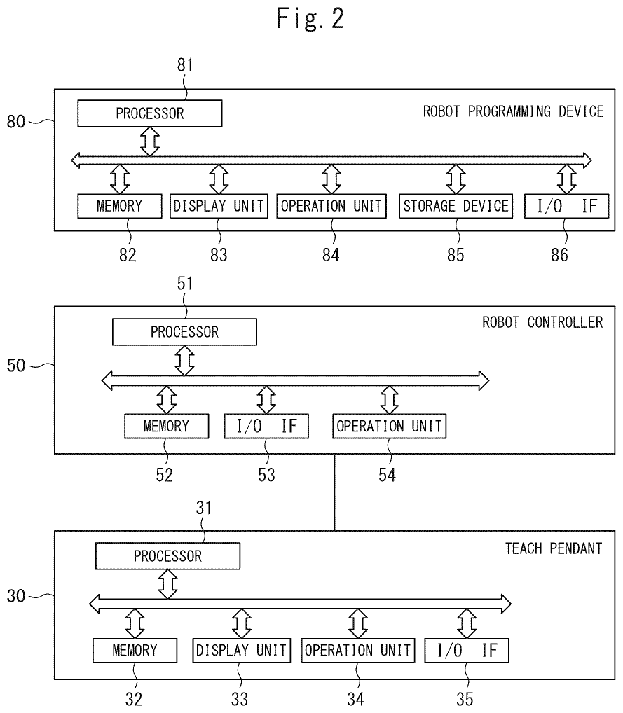

FIG. 2 illustrates hardware configuration examples of the robot programming device 80, the robot controller 50, and the teach pendant 30. The robot programming device 80 has a hardware configuration as a common computer including a memory 82 (such as a ROM, a RAM, or a nonvolatile memory), a display unit 83, an operation unit 84 configured with input devices such as a keyboard and a mouse, a storage device 85 (such as a HDD), various input-output interfaces 86, etc. that are connected to a processor 81. The robot controller 50 may have a configuration as a common computer including a memory 52 (such as a ROM, a RAM, or a nonvolatile memory), various input-output interfaces 53, an operation unit 54 including various operation switches, etc. that are connected to a processor 51 through a bus. The teach pendant 30 may have a configuration as a common computer including a memory 32 (such as a ROM, a RAM, or a nonvolatile memory), a display unit 33, an operation unit 34 configured with an input device such as a keyboard (or a software keyboard), various input-output interfaces 35, etc. that are connected to a processor 31 through a bus.

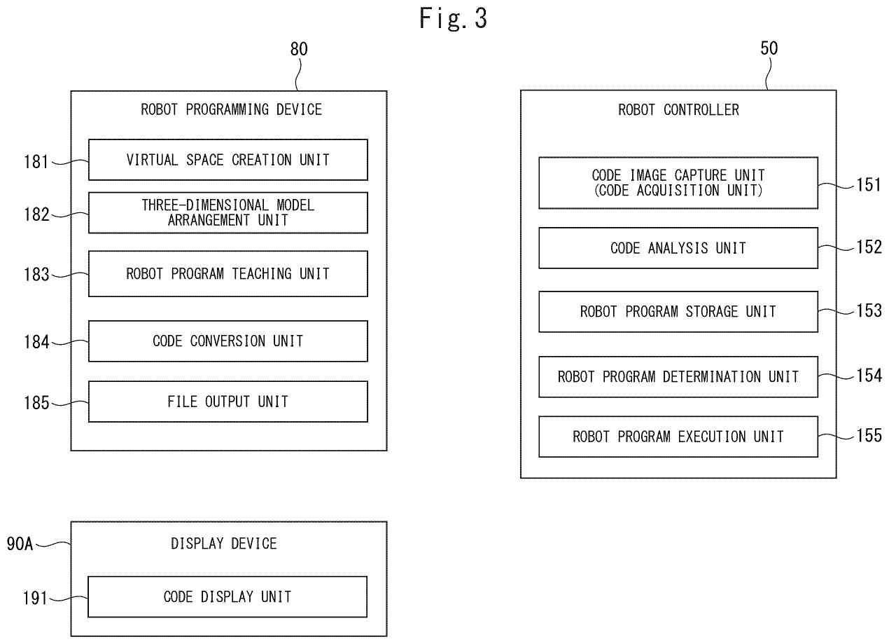

FIG. 3 illustrates functional block diagrams of the robot programming device 80 and the robot controller 50. As illustrated in FIG. 3, the robot programming device 80 includes a virtual space creation unit 181, a three-dimensional model arrangement unit 182, a robot program teaching unit 183, a code conversion unit 184, and a file output unit 185.

In the robot programming device 80, the virtual space creation unit 181 creates a virtual space for arranging various models constituting a robot system. The three-dimensional model arrangement unit 182 arranges, in the virtual space, a three-dimensional model of each object constituting the robot system including a robot model, based on arrangement information of the actual robot system 110. The robot system model arranged in the virtual space is displayed on a display screen of the robot programming device 80.

The robot program teaching unit 183 provides a function for performing the teaching of a robot program. For example, the robot program teaching unit 183 has a function of accepting operations for performing a jog operation on a robot model arranged in the virtual space, specifying teaching points, and setting various parameters, etc. through a user interface screen, and generating a robot program in accordance with the user inputs. The function of the robot program teaching unit 183 includes a function of executing a kinematical calculation (a simulation) related to the position and the posture of a robot model (and a tool model) and each joint position (angle), based on the user inputs as described above.

The code conversion unit 184 has a function of converting information for identifying a created robot program (a program name or a program ID) into a code.

The file output unit 185 provides a function of outputting the generated code as a file (such as an image file). Consequently, a code generated on the robot programming device 80 can be provided to another device (such as a display device or a printer) through, for example, a network.

As described above, a code generated by the robot programming device 80 can be displayed on the information medium 90. As an example, a display device 90A for displaying a code may be used as illustrated in FIG. 3. The display device 90A includes a code display unit 191 configured to display a code. The display device 90A may be one of various information processing devices including a display screen, such as a tablet terminal or a smartphone. A code generated as a file by the robot programming device 80 is transferred to the display device 90A through an external memory or a network. In this case, the display screen of the display device 90A is the information medium 90. The robot system 110 can read and decode a code displayed on the display device 90A.

The robot controller 50 includes a code image capture unit 151, a code analysis unit 152, a robot program storage unit 153, a robot program determination unit 154, and a robot program execution unit 155.

The code image capture unit 151 has a function of capturing an image of a code displayed on the information medium 90 by using the visual sensor 21. For example, the code image capture unit 151 may operate in such a way as to capture an image of the information medium 90 previously arranged within the image capture range of the visual sensor 21 or may operate in such a way as to capture an image of the information medium 90 while controlling the robot 10. The function of the code image capture unit 151 may be expressed as a code acquisition unit that acquires an image of a code indicating information for identifying a program, wherein the image is captured by the visual sensor 21.

The robot controller 50 may have a function as a visual sensor controller for controlling the visual sensor 21 as an internal function of the robot controller 50. Alternatively, a visual sensor controller for controlling the visual sensor 21 may be arranged in the robot system 110 as a device separately provided from the robot controller 50. In the latter configuration, the robot controller 50 controls the visual sensor 21 through the visual sensor controller and acquires an image captured by the visual sensor 21 through the visual sensor controller.

By analyzing a captured image of a code, the code analysis unit 152 extracts an area of the code in the image, determines the position and the posture of the code, and decodes information encoded in the code.

The robot program storage unit 153 stores a robot program being generated by the robot programming device 80 and being provided to the robot controller 50 through, for example, an external memory. Whan a program ID is used as information for identifying a robot program, the robot program storage unit 153 holds a table in which a program ID is associated with a robot program.

The robot program determination unit 154 determines a robot program corresponding to information for identifying a robot program (a program name or a program ID) decoded by the code analysis unit 152 out of robot programs previously stored in the robot program storage unit 153.

The robot program execution unit 155 executes a robot program determined by the robot program determination unit 154. For example, the robot program execution unit 155 interprets a robot program, sets a trajectory plan of a predetermined control part of a robot based on the robot program, and generates an operation command for each axis based on the trajectory plan to execute servo control of a motor for each axis.

By the functions of the robot controller 50 described above, the robot controller 50 can read a code displayed on the information medium 90 and execute a robot program determined by the information indicated by the code.

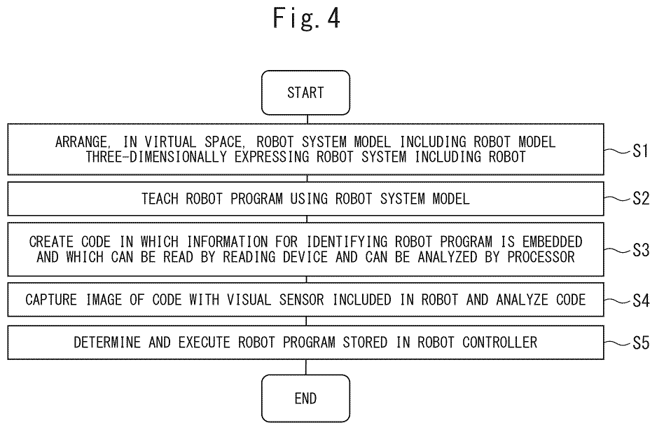

FIG. 4 is a flowchart illustrating a sequence of processing executed in the robot programming system 100, from creation of a robot program to readout of a code and further to execution of the robot program.

First, a robot system model including a robot model three-dimensionally expressing a robot system including a robot is arranged in a virtual space in the robot programming device 80 (step S1). The processing in this step S1 is executed by the functions of the virtual space creation unit 181 and the three-dimensional model arrangement unit 182.

Next, teaching using the robot system model (programming) is performed (step S2). The teaching herein is performed by, for example, an operator operating the robot model in the virtual space and specifying teaching points by using the function provided by the robot program teaching unit 183.

Next, in step S3, a code in which information for identifying the robot program is embedded and which can be read by the visual sensor 21 as a reading device and can be analyzed by the robot controller, is generated. The processing in step S3 is executed as a function of the code conversion unit 184.

Next, in step S4, by capturing, with the visual sensor 21, an image of the code being generated in step S3 and being displayed on the information medium 90 and analyzing the image, the information embedded in the code (such as a program name or a program ID) is decoded. The processing herein is performed as the function of the code analysis unit 152.

Next, the robot program determination unit 154 determines a robot program corresponding to the information decoded in step S4 (such as a program name or a program ID) out of robot programs preregistered in the robot program storage unit 153. Then, the robot program execution unit 155 executes the determined robot program (step S5).

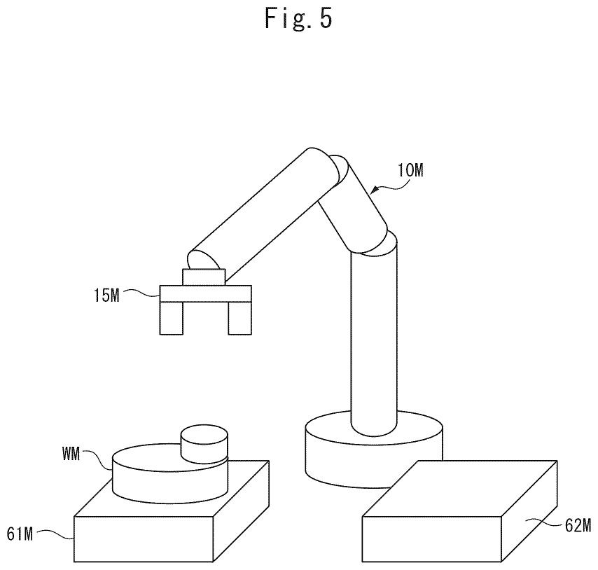

A specific operation example using the robot programming system 100 will be described below. An example of creating a program for performing pick-up of a workpiece as a robot program will be described. FIG. 5 illustrates a state of a robot model 10M, a workpiece model WM, and peripheral device models 61M and 62M being arranged by the three-dimensional model arrangement unit 182 in a virtual space created by the virtual space creation unit 181. In this example, a hand model 15M is attached to an arm tip of the robot model 10M as an end effector. The state of the models being arranged in the virtual space is displayed on the display screen of the robot programming device 80.

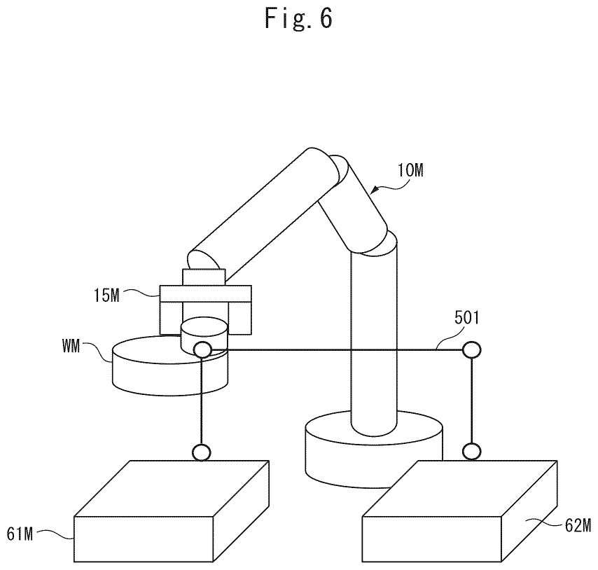

An operator performs teaching of a robot program under support by the robot program teaching unit 183. An example of teaching, to the robot model, an operation of picking up the workpiece model WM placed on the peripheral device model 61M and arranging the workpiece model WM on the peripheral device model 62M will be described. As an example, teaching is performed by adjusting teaching points one by one through a jog operation on the robot model 10M in the virtual space as illustrated in FIG. 6. The operator specifies a position where the workpiece model WM is picked up and a position where the workpiece model WM is arranged in the virtual space, and further specifies a position of the workpiece model WM relative to the hand model 15M when the workpiece model WM is held by the hand model 15M. The robot program teaching unit 183 automatically generates a robot program 501 in accordance with the thus specified teaching content. FIG. 6 schematically illustrates a state of the robot program 501 being generated. The robot program 501 in this case includes information about operation instructions and teaching points for holding the workpiece model WM by positioning the hand model 15M at the pick-up position and arranging the workpiece model WM by moving the hand model 15M to the arrangement position through a standby position, etc.

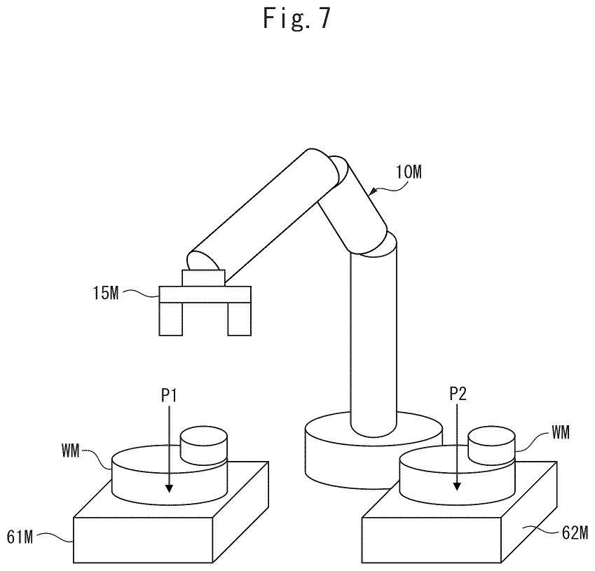

The pick-up operation of a workpiece may also be generated by a teaching technique as follows. FIG. 7 illustrates a state of the robot model 10M, the workpiece model WM, and the peripheral device models 61M and 62M being arranged in the virtual space (display screen). As illustrated in FIG. 7, the hand model 15M is attached to the arm tip of the robot model 10M in this example.

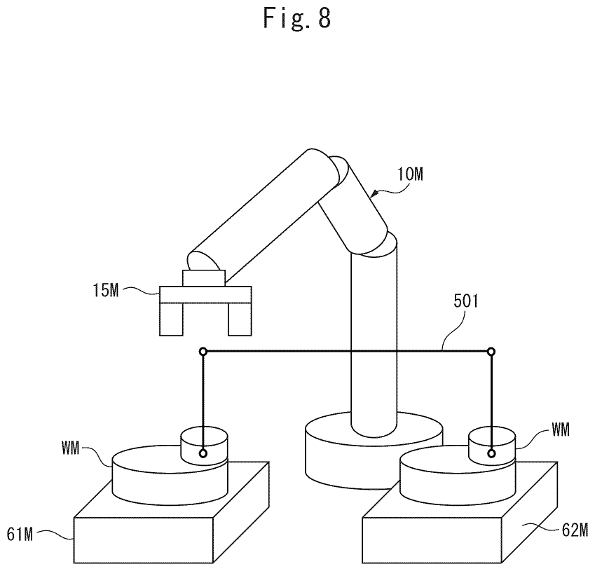

The operator specifies a pick-up position P1 and an arrangement position P2 of the workpiece WM by operating the robot model 10M in the virtual space (display screen) in this example. As illustrated in FIG. 8, the robot program teaching unit 183 automatically generates a robot program 501 for picking up the workpiece model WM from the pick-up position P1 and arranging the workpiece model WM at the arrangement position P2 by using the hand model 15M. The robot program 501 includes information about operation instructions and teaching points for holding the workpiece model WM by positioning the hand model 15M at the pick-up position P1 and arranging the workpiece model WM by moving the hand model 15M to the arrangement position P2 through way points.

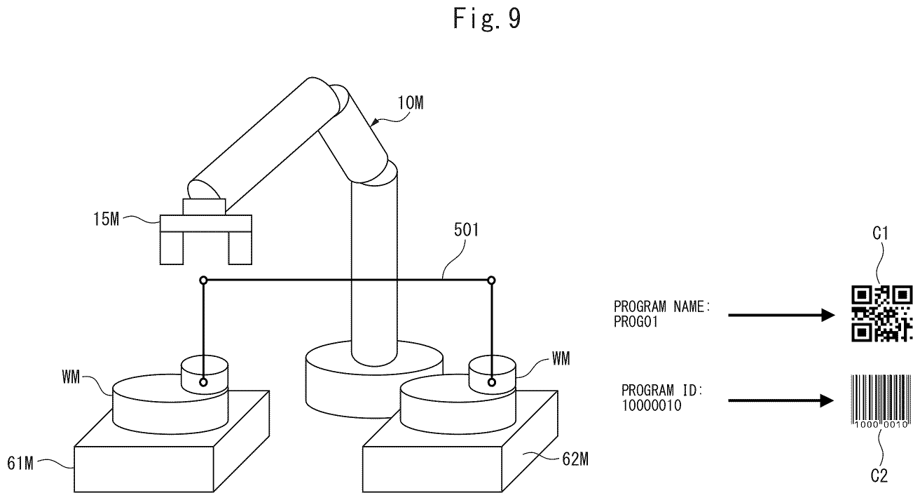

The code conversion unit 184 converts information for identifying the robot program 501 created as described above into a code. FIG. 9 schematically illustrates a state of a code being generated by the code conversion unit 184. As illustrated in FIG. 9, when a program name is used as information for identifying the robot program 501, the code conversion unit 184 converts the program name (such as PROG01) into a two-dimensional code C1. When a program ID is used as information for identifying the robot program 501, the code conversion unit 184 converts the program ID (such as 10000010) into a one-dimensional code C2. When a program ID is used as information for identifying a robot program, the robot program teaching unit 183 may create a table in which a program ID is associated with a robot program (such as a program name) and provide the table to the robot controller 50.

A generated robot program 501 (and a table in which a program ID is associated with a robot program when a program ID is used) is registered in the robot controller 50 through, for example, a USB memory. The robot program 501 is stored in the robot program storage unit 153, and the robot controller 50 enters a state in which the robot program 501 can be executed.

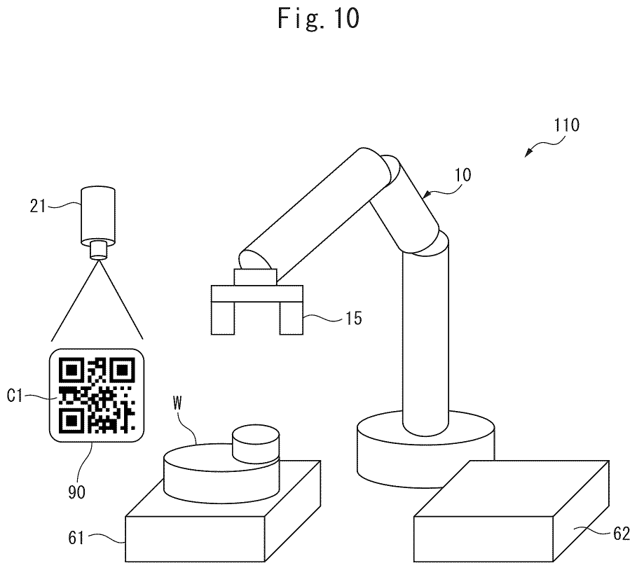

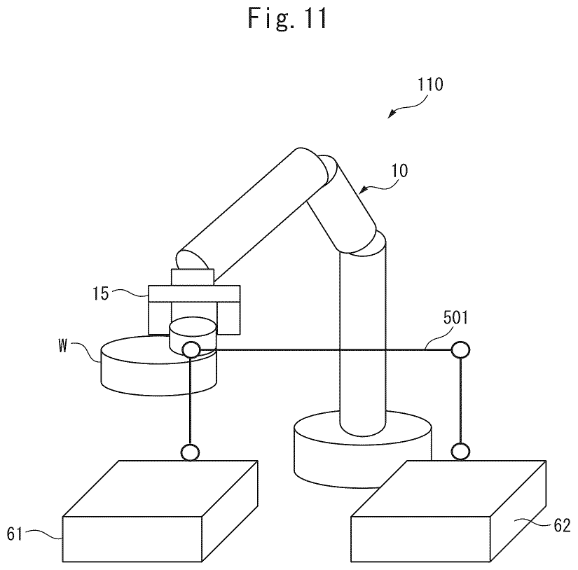

Next, an operation in a stage of readout of a code by the actual robot system 110 will be described with reference to FIG. 10 and FIG. 11. As illustrated in FIG. 10, when a workpiece W is put into the workspace, the robot controller 50 captures an image of a code (assumed to be the code C1) displayed on the information medium 90 by using the visual sensor 21. The captured image of the code is analyzed by the code analysis unit 152, and information for identifying the robot program 501 (such as a program name: PROG01) is decoded. As described above, the information medium 90 may be, for example, the display screen of the display device 90A, the display screen of the robot programming device 80, or a print medium affixed to a workpiece.

The robot program determination unit 154 determines the robot program 501 corresponding to the decoded information (such as the program name: PROG01) out of robot programs stored in the robot program storage unit 153. Consequently, as schematically illustrated in FIG. 11, the robot program execution unit 155 can execute the determined robot program 501.

Thus, the robot controller 50 according to the first embodiment can decode information for identifying a program by analyzing a captured image of a code, select a robot program corresponding to the decoded information out of a plurality of preregistered robot programs, and execute the program. Consequently, a robot program can be efficiently applied to a robot system even in situations in which the production situation of the robot system changes variously.

### Second Embodiment

A second embodiment will be described below. The second embodiment is a configuration example when a robot program dependent on a workpiece is created in a robot programming device. An apparatus configuration and a hardware configuration of a robot programming system according to the second embodiment are equivalent to the configurations according to the first embodiment illustrated in FIG. 1 and FIG. 2.

According to the present embodiment, a code is affixed at a predetermined position on a workpiece, and the code affixed to the workpiece is read when a robot 10 executes work. In this specification, a robot program being dependent on a workpiece refers to operation contents of a robot program being dependent on, for example, the type of workpiece or the number of workpieces.

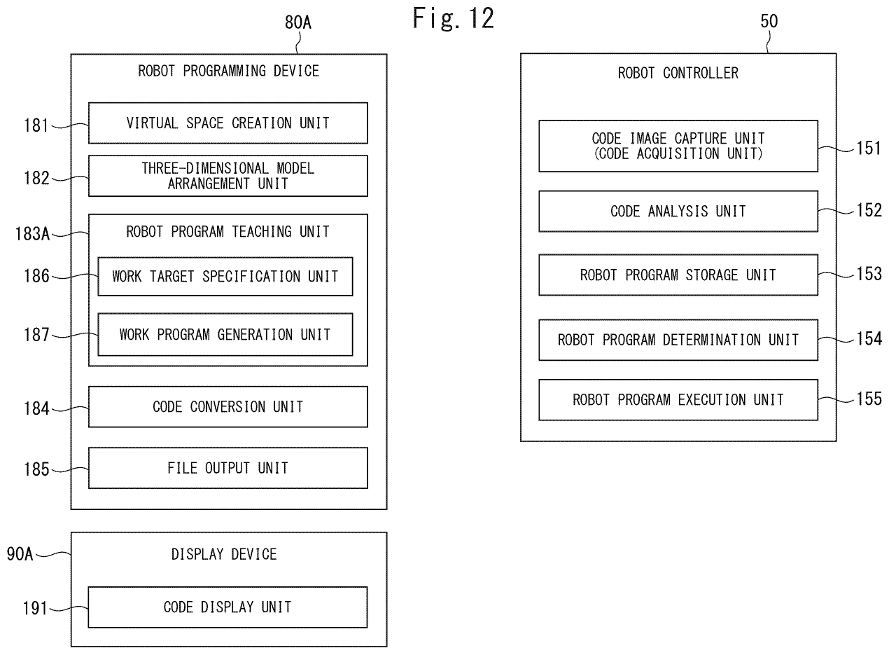

FIG. 12 illustrates functional block diagrams of a robot programming device 80A and a robot controller 50 according to the second embodiment. In FIG. 12, a functional block being the same as a functional block according to the first embodiment is given the same sign. As a configuration for automatically generating a robot program dependent on a workpiece, a robot program teaching unit 183A in the robot programming device 80A according to the second embodiment includes a work target specification unit 186 and a work program generation unit 187.

The work target specification unit 186 has a function of assisting an operation of specifying, by an operator, a work target part in a workpiece model displayed in a virtual space (display screen), based on a geometric characteristic (such as an outline and/or a plane) of a workpiece W that can be extracted from a three-dimensional model of the workpiece W, and determining the specified work target part.

The work program generation unit 187 automatically generates a robot program for executing predetermined work using a work tool on the work target part determined by the work target specification unit 186.

An example of generating a robot program dependent on a workpiece in the robot programming device 80A will be described below.

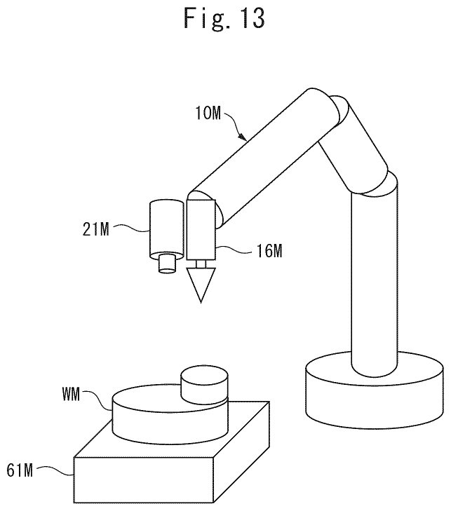

FIG. 13 to FIG. 15 are diagrams illustrating a first creation example of a robot program dependent on a workpiece. FIG. 13 illustrates a state of a robot model 10M, a workpiece model WM, and a peripheral device model 61M being arranged in a virtual space (display screen) by the robot programming device 80A. In this example, a visual sensor model 21M and a grinding tool model 16M as a work tool are attached to an arm tip of the robot model 10M.

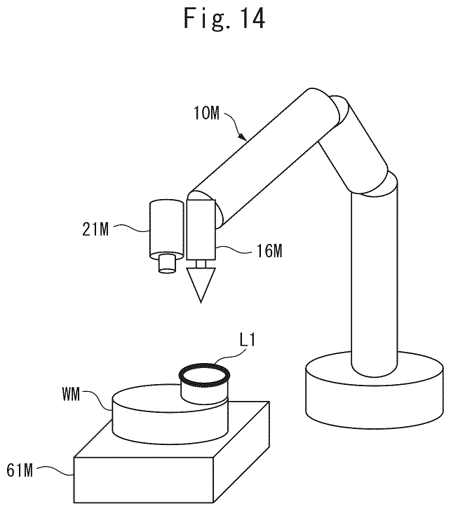

FIG. 14 illustrates a state of an operator specifying an edge line L1 of an upper cylinder of the workpiece model WM as a work target part under support by the work target specification unit 186.

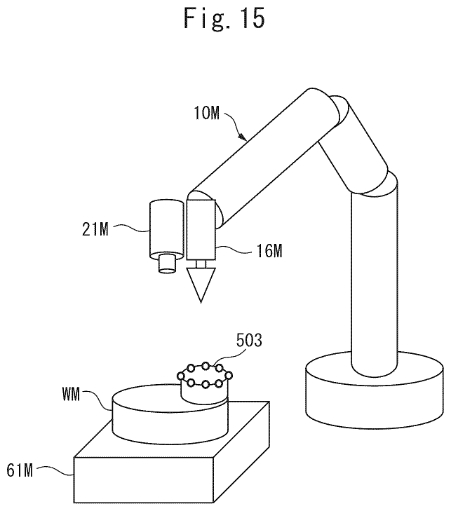

Next, as illustrated in FIG. 15, the work program generation unit 187 automatically generates a robot program 503 for executing grinding work by moving the grinding tool model 16M along the specified edge line L1. The robot program 503 in this case includes information about a plurality of teaching points along the edge line L1 and operation instructions for moving the grinding tool model 16M along the edge line L1 through the teaching points.

The generated robot program 503 is registered in the robot controller 50 through, for example, a USB memory.

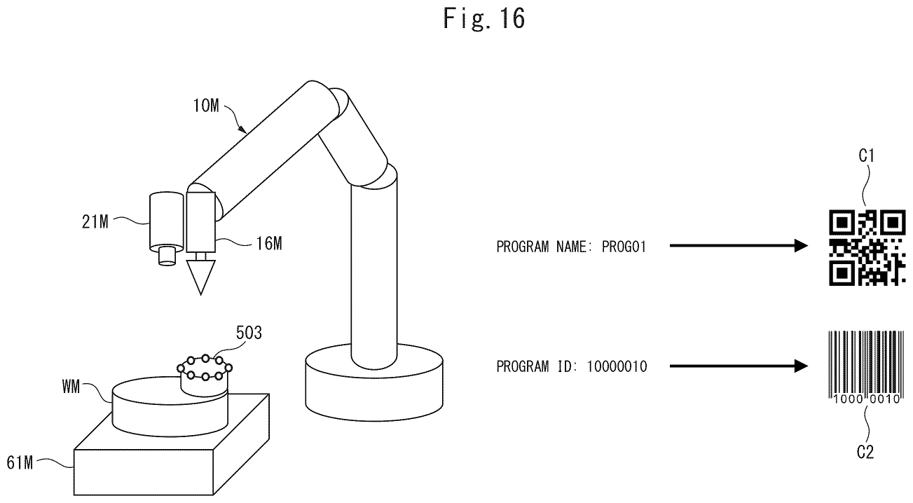

As schematically illustrated in FIG. 16, the code conversion unit 184 converts information for identifying the robot program 503 created as described above into a code. FIG. 16 schematically illustrates a state of a code being generated by the code conversion unit 184. As illustrated in FIG. 16, when a program name is used as the information for identifying the robot program 503, the code conversion unit 184 converts the program name (such as PROG01) into a two-dimensional code C1. When a program ID is used as the information for identifying the robot program 503, the code conversion unit 184 converts the program ID (such as 10000010) into a one-dimensional code C2.

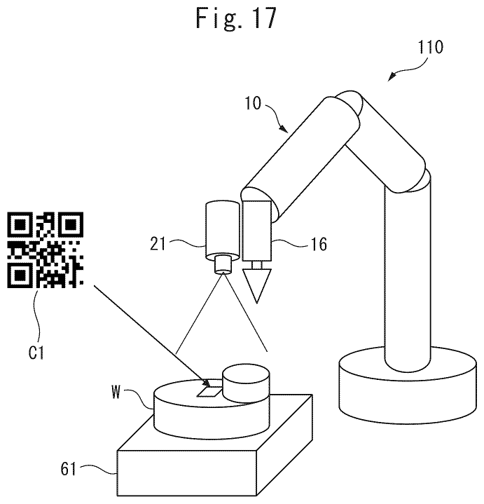

The thus generated code is affixed at a predetermined position on the workpiece W (a position an image of which can be captured by a visual sensor 21) before the work starts (see FIG. 17).

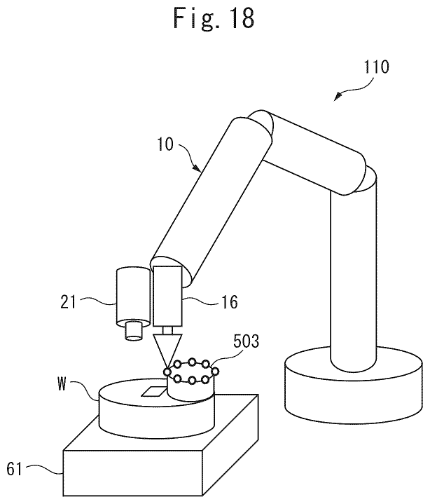

As illustrated in FIG. 17, when the workpiece W is put into a workspace, the robot 10 (robot controller 50) captures an image of the code C1 affixed at the predetermined position on the workpiece W by using the visual sensor 21. The image is analyzed by the code analysis unit 152, and the information for identifying the robot program 503 is decoded. The robot program determination unit 154 determines the robot program 503 corresponding to the decoded information (such as a robot program name or a program ID) out of robot programs stored in the robot program storage unit 153. The robot program execution unit 155 executes the determined robot program 503 (see FIG. 18).

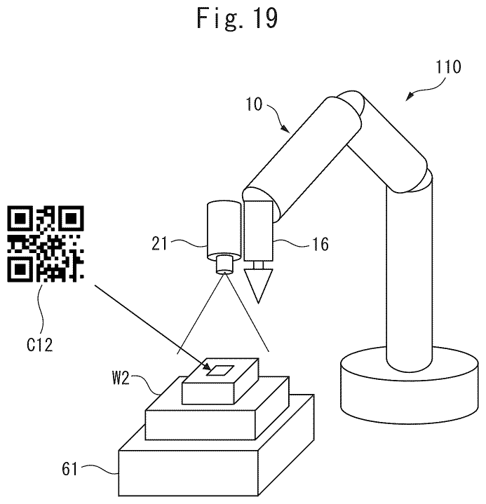

It is assumed that another workpiece W2 is put into the workspace of the robot 10 after the work on the workpiece W (execution of the robot program 503) is completed, as illustrated in FIG. 19. A code C12 representing information for identifying a robot program to be executed on the workpiece W2 is affixed to the workpiece W2. The robot 10 (robot controller 50) decodes information for identifying a program encoded in the code C12 by reading the code C12 affixed to the workpiece W2 by using the visual sensor 21 in this case as well. Then, the robot controller 50 determines a robot program corresponding to the decoded information out of the robot programs stored in the robot program storage unit 153.

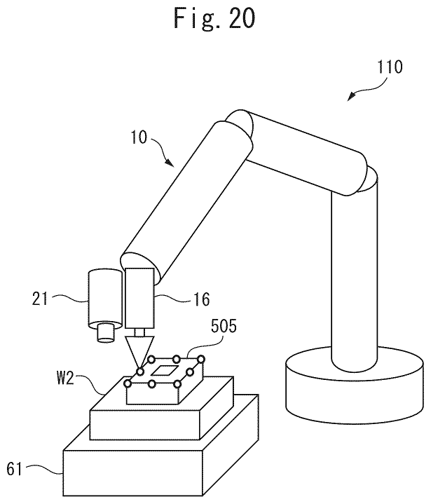

Consequently, as illustrated in FIG. 20, the robot program execution unit 155 can obtains the determined robot program 505 from the robot program storage unit 153 and execute the program. When a program ID is used as information for identifying a robot program, the robot program determination unit 154 holds a table in which a program ID is associated with a robot program (such as a program name). Such a correspondence table in which a program ID is associated with a program (program name) may be previously created on the robot programming device 80A side and be provided to the robot controller 50 side.

Thus, the robot controller 50 according to the second embodiment can decode information for identifying a program by analyzing a captured image of a code and can select a robot program corresponding to the decoded information out of a plurality of preregistered programs and execute the program. Consequently, a robot program can be efficiently applied to a robot system even in situations in which the production situation of the robot system changes variously.

According to the second embodiment in particular, a robot program dependent on a workpiece is generated, and a code indicating information for identifying such a robot program is created and affixed to a workpiece. Accordingly, a robot program can be efficiently applied to a robot system even in situations in which work is performed on various types of workpieces in the robot system.

### Third Embodiment

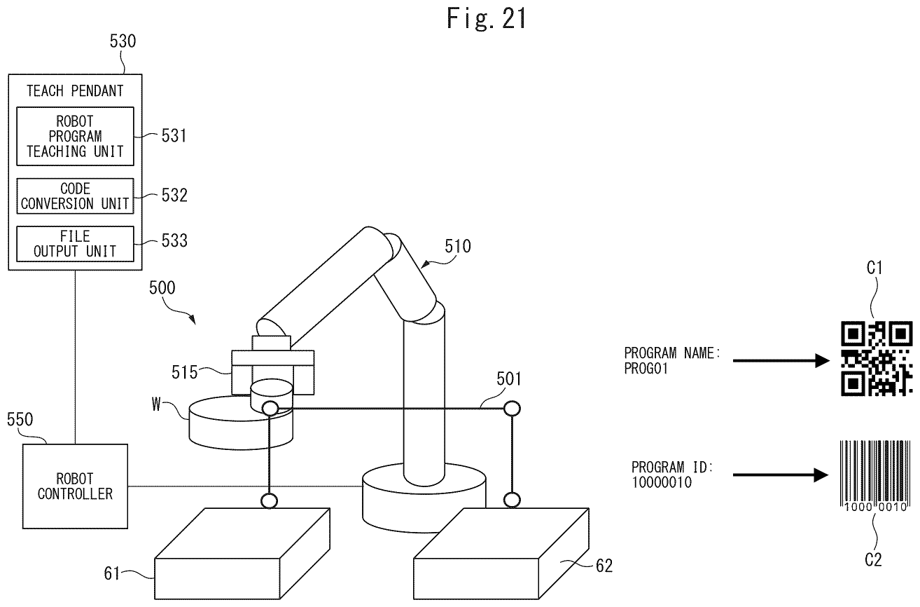

A third embodiment will be described below with reference to FIG. 21. The third embodiment relates to a configuration for applying a robot program created by teaching the operation to an actual robot system, to another robot system. An actual robot system to be used for creation of a robot program is assumed to be a robot system 500 illustrated in FIG. 21.

The robot system 500 includes a robot 510, a robot controller 550 controlling the robot 510, and a teach pendant 530 for teaching the operation to the robot 510. In this configuration, the teach pendant 530 functions as a robot programming device for creating a robot program. FIG. 21 also illustrates a functional block diagram of the teach pendant 530.

As illustrated in FIG. 21, the teach pendant 530 includes a robot program teaching unit 531, a code conversion unit 532, and a file output unit 533. The robot program teaching unit 531 provides various functions for teaching (programming) including performing a jog operation on the robot 510 and setting operation parameters. An operator creates a robot program under support by the robot program teaching unit 531.

It is assumed in the robot system 500 that a robot program 501 is created by operating the actual robot 510 by using the teach pendant 530 as illustrated in FIG. 21. The generated robot program 501 can be registered in the robot system 110 (robot controller 50) illustrated in FIG. 1 through, for example, a USB memory.

The code conversion unit 532 in the teach pendant 530 converts information for identifying the robot program 501 into a code. FIG. 21 schematically illustrates a state of a code being generated by the code conversion unit 532. As illustrated in FIG. 21, when a program name is used as the information for identifying the robot program 501, the code conversion unit 532 converts the program name (such as PROG01) into a two-dimensional code C1. When a program ID is used as the information for identifying the robot program 501, the code conversion unit 532 converts the program ID (such as 10000010) into a one-dimensional code C2.

The file output unit 533 provides a function of outputting a generated code as a file (such as an image file). Since the generated code can also be output by the file output unit 533 as a file, the code may be printed on a print medium or be displayed on a display screen of a display device so that the code can be read by the robot system 110 as illustrated in FIGS. 10 and 11.

Alternatively, the teach pendant 530 may also function as a display device displaying a code. In this case, the teach pendant 530 further has a function as a code display unit displaying a code. A code displayed on the teach pendant 530 may be read and executed by the robot system 110 illustrated in FIG. 1.

Also, in the third embodiment, a code generated by the teach pendant 530 may be displayed on various media as information media 90.

Thus, according to the third embodiment, a robot program can be efficiently applied to a robot system even in a situation where a robot program created by an actual robot system is applied to another robot system.

As described above, the robot controller according to each embodiment can decode information for identifying a program by analyzing a captured image of a code, select a robot program corresponding to the decoded information out of a plurality of preregistered programs, and execute the program. Consequently, a robot program can be efficiently applied to a robot system even in situations in which the production situation of the robot system changes variously.

In other words, in situations in which the production situation of a robot system changes variously, time and man-hours required for applying a robot program to the robot system can be considerably reduced compared with a case where the robot system is temporarily stopped and an operation for re-selecting a suitable robot program is performed or a case where a program for calling up a suitable robot program is newly created on the user side.

According to each embodiment described above, a small amount of information, such as a program name or a program ID, is encoded as information for identifying a robot program, and therefore, an amount of information embedded in the code can be reduced. Consequently, the size of the code itself can be reduced, and analysis of the code can be promptly executed.

While the present invention has been described above by using the typical embodiments, it may be understood by a person skilled in the art that changes, and various other changes, omissions, and additions can be made to the aforementioned embodiments without departing from the scope of the present invention.

While a program name and a program ID have been described as examples of information for identifying a robot program in the above embodiments, the information for identifying a robot program is not limited thereto. Another type of information for uniquely identifying a robot program may be used.

As information to be encoded in a code, additional information may be added to the information for identifying a robot program in each embodiment described above. For example, in a situation in which a plurality of robots executing a specific program exist, the code conversion unit may convert, in addition to the program name, information for identifying a robot by which the specific program is executed, into a code. A two-dimensional code can hold a relatively large amount of information and therefore can be suitably used in an embodiment in which the additional information is added to the information for identifying a robot program.

Functional blocks in a functional block diagram exemplified as a diagram illustrating a functional configuration of the robot programming device or the robot controller in the embodiments described above may be provided by executing various types of software stored in the storage device by the processor in the robot programming device or the robot controller or may be provided by a configuration mainly based on hardware such as an application specific integrated circuit (ASIC).

The program executing various types of processing in a series of operations from creation of a robot program to determination and execution of the robot program in the embodiments described above can be recorded on various computer-readable recording media (such as semiconductor memories such as a ROM, an EEPROM, and a flash memory; a magnetic recording medium; and optical disks such as a CD-ROM and a DVD-ROM).

### REFERENCE SIGNS LIST

10 Robot
15, 515 Hand
30 Teach pendant
50 Robot controller
80 Robot programming device
31, 51, 81 Processor
32, 52, 82 Memory
33, 83 Display unit
34, 54, 84 Operation unit
35, 53, 86 Input-output interface
85 Storage device
90 Information medium
90A Display device
100 Robot programming system
110 Robot system
151 Code image capture unit
152 Code analysis unit
153 Robot program storage unit
154 Robot program determination unit
155 Robot program execution unit
181 Virtual space creation unit
182 Three-dimensional model arrangement unit
183, 183A Robot program teaching unit
184 Code conversion unit
185 File output unit
186 Work target specification unit
187 Work program generation unit
191 Code display unit
10M Robot model
15M Hand model
61M, 62M Peripheral device model
500 Robot system
510 Robot
530 Teach pendant
531 Robot program teaching unit
532 Code conversion unit
533 File output unit
550 Robot controller

1. A robot programming device comprising:
a robot program teaching unit configured to perform teaching of a robot program; and
a code conversion unit configured to convert information for identifying the taught robot program into a code.

2. The robot programming device according to claim 1, further comprising:
a three-dimensional model arrangement unit configure to arrange, in a virtual space, a robot system model including a robot model three-dimensionally expressing a robot system including a robot, wherein
the robot program teaching unit is configured to accept teaching of the robot program by an operation on the robot system model.

3. The robot programming device according to claim 1, wherein
the robot program is a program having a property dependent on a workpiece being a work target.

4. The robot programming device according to claim 3, wherein
the robot program teaching unit includes:
a work target specification unit configured to accept an operation for specifying, based on a geometric characteristic of a workpiece model, a work target part on the workpiece model; and
a work program generation unit configured to generate a robot program for performing work by a work tool on the specified work target part.

5. The robot programming device according to claim 1, wherein
the code conversion unit adds, as additional information, information for identifying a robot by which the robot program is executed, to the information for identifying the robot program and converts the information for identifying the robot program to which the additional information is added into a code.

6. The robot programming device according to claim 1, further comprising a file output unit configured to output the code generated by the code conversion unit as a file.

7. The robot programming device according to claim 1, wherein
the information for identifying the robot program is one of a program name and a program ID of the robot program.

8. A robot programming system comprising:
a robot programming device including:
a robot program teaching unit configured to perform teaching of a robot program; and
a code conversion unit configured to convert information for identifying the taught robot program into a code;
a visual sensor configured to capture an image of the code displayed on an information medium; and
a robot controller configured to control a robot, the robot controller including:
a code analysis unit configured to decode the information for identifying the robot program by analyzing the captured image of the code;
a robot program determination unit configured to determine, based on the decoded information for identifying the robot program, a robot program corresponding to the information for identifying the robot program from one or more preregistered robot programs; and
a robot program execution unit configured to execute the determined robot program.

9. The robot programming system according to claim 8, wherein
the robot programming device further includes a three-dimensional model arrangement unit configured to arrange, in a virtual space, a robot system model including a robot model three-dimensionally expressing a robot system including the robot, and
the robot program teaching unit is configured to accept teaching of the robot program by an operation on the robot system model.

10. The robot programming system according to claim 8, further comprising a display device including a display screen as the information medium on which the code is displayed.

11. The robot programming system according to claim 8, wherein
the information medium on which the code is displayed is a print medium and is affixed at a predetermined position on a workpiece as a work target.

12. The robot programming system according to claim 8, wherein
the robot program is a program having a property dependent on a workpiece being a work target.

13. The robot programming system according to claim 12, wherein
the robot program teaching unit includes:
a work target specification unit configured to accept an operation for specifying, based on a geometric characteristic of a workpiece model, a work target part on the workpiece model; and
a work program generation unit configured to generate a robot program for performing work by a work tool on the specified work target part.

14. The robot programming system according to claim 8, wherein
the robot programming device is a teaching device configured to generate the robot program by teaching operation to an actual robot.

15. The robot programming system according to claim 8, wherein
the code conversion unit adds, as additional information, information for identifying a robot by which the robot program is executed, to the information for identifying the robot program and converts the information for identifying the robot program to which the additional information is added into a code.
